(19) United States
(12) Patent Application Publication
(10) Pub. No.: US 2025/0346113 A1
(43) Pub. Date: Nov. 13, 2025

(54) ELECTRIC AXLE WITH TWO-SPEED HIGH RATIO OFFSET-REDUCER FOR HIGH TORQUE APPLICATIONS

(71) Applicant: Schaeffler Technologies AG & Co. KG, Herzogenaurach (DE)

(72) Inventor: Benedikt Neubauer, Herzogenaurach (DE)

(73) Assignee: Schaeffler Technologies AG & Co. KG, Herzogenaurach (DE)

(21) Appl. No.: 18/660,864

(22) Filed: May 10, 2024

(51) Int. Cl. B60K 1/00; B60K 17/08

(52) U.S. Cl. CPC B60K 17/08; B60K 2001/001; F16H 2048/368; F16H 2200/0034; F16H 2200/2035

(57) ABSTRACT

An electric beam axle for a hybrid or electric vehicle. The electric beam axle includes an electric motor, a shiftable high ratio offset reducer coupled to the electric motor, and a final drive connectable to a first vehicle wheel and a second vehicle. The shiftable high ratio offset reducer includes a compound planetary gearset, and the final drive includes a differential. The components can be arranged in an offset configuration.

### FIELD OF INVENTION

The present disclosure related to a drivetrain for a vehicle. It is particularly concerned with a two-speed gear train for an electric axle for an electric or hybrid vehicle.

### BACKGROUND

Electric beam axles are used in hybrid and electric vehicles to transfer rotational energy from an electric motor to the wheels of the vehicle, causing the vehicle to propel in a specified direction. Electric beam axles include the electric motor and the gearing/gearbox required to transfer the rotational energy from the electric motor to the wheels of the vehicle. Based on design requirements, there is a limited space envelope in which the electric motor and the gearing/gearbox must be positioned within the electric beam axle. In addition, electric beam axles for truck applications often require high and low range gearing capabilities for normal and high torque driving conditions, respectively. Therefore, there is a need for an electric beam axle that can efficiently fit the electric motor and the gearing/gearbox for a hybrid and/or electric vehicle within a limited space envelope while maintaining full functionality and high and low range gearing capabilities.

### SUMMARY

In one aspect, the present disclosure is directed to an electric beam axle for a hybrid or electric vehicle. The electric beam axle includes an electric motor, a shiftable high ratio reducer coupled to the electric motor, and a final drive coupled to the shiftable high ratio offset reducer and connectable to a vehicle wheel. The final drive is offset axially from at least one of the electric motor or shiftable high ratio reducer.

The shiftable high ratio reducer can include a planetary gearset having a plurality of stepped planet gears supported by a planet carrier. The planetary gearset can include a first ring gear and a second ring gear. Each stepped planetary gear can include a large planetary gear meshing with the first ring gear and a small planetary gear meshing with the second ring gear, and wherein the large planetary gear and small planetary gear rotate together and are coupled in a way that torque can be transferred. The planetary gearset can include at least one first clutch for selectively engaging the planet carrier with the final drive in a first drive mode. The at least one clutch can selectively engage the second ring gear with the final drive in a second drive mode. The planetary gearset can have a first gear ratio of between about 1:7.5 to 1:10, and a second gear ratio of between about 1:2.5 to 1:7.5. Other ratios are also feasible. The shiftable high ratio reducer can include an input shaft coupled to the electric motor. The final drive can include at least one of a spur gear differential or a bevel gear differential.

In accordance with another aspect, a gear train for an electric vehicle includes a shiftable high ratio reducer, and a final drive coupled to the shiftable high ratio reducer and connectable to a vehicle wheel. The final drive is offset axially from the shiftable high ratio reducer. The shiftable high ratio reducer can include a planetary gearset having a plurality of stepped planet gears supported by a planet carrier. The planetary gearset can include a first ring gear and a second ring gear. Each stepped planetary gear includes a large planetary gear meshing with the first ring gear and a small planetary gear meshing with the second ring gear, and the large planetary gear and small planetary gear rotate together and are coupled in a way that torque can be transferred. The planetary gearset can include at least one clutch for selectively engaging the planet carrier with the final drive in a first drive mode. The at least one clutch can selectively engaging the second ring gear with the final drive in a second drive mode. The planetary gearset can have a first gear ratio of between about 1:7.5 to 1:10, and a second gear ratio of between about 1:2.5 to 1:7.5. The shiftable high ratio reducer can include an input shaft. The final drive can include at least one of a spur gear differential or a bevel gear differential.

### BRIEF DESCRIPTION OF THE DRAWING(S)

The foregoing Summary as well as the following Detailed Description will be best understood when read in conjunction with the appended drawings, which illustrate a preferred embodiment according to the disclosure. In the drawings:

FIG. 1 is a schematic illustration of an exemplary electric beam axle for a hybrid and/or electric vehicle in accordance with the present disclosure.

### DETAILED DESCRIPTION OF THE PREFERRED EMBODIMENT(S)

Certain terminology is used in the following description for convenience only and is not limiting. The words “front”, “rear”, “upper”, and “lower” designate directions in the drawings to which reference is made. The words “inwardly” and “outwardly” refer to directions towards and away from parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terms “generally” and “approximately” are to be construed as within 10% of a stated value or ratio. The terminology includes the words specifically noted above, derivatives thereof, and words of similar import.

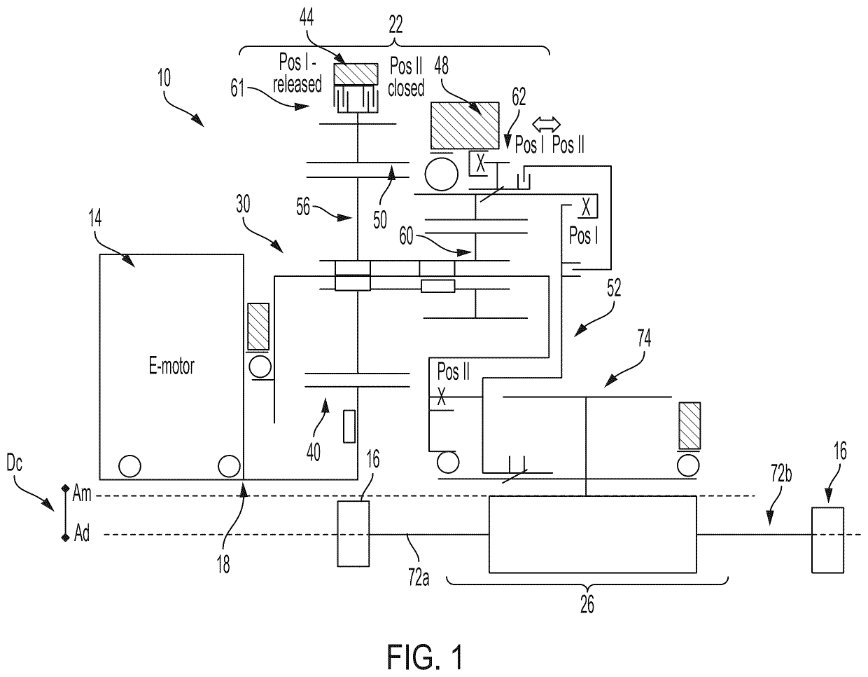

FIG. 1 is a schematic illustration of an exemplary electric beam axle 10 for use in a hybrid and/or electric vehicle. FIG. 1 schematically illustrates only one half of a gearbox of the electric beam axle 10, but it is to be understood that at least some of the components and features of the gearbox are axially aligned with and surround an axis of rotation of the electric beam axle 10, discussed further below. In some examples, the axis of rotation can be an axis of rotation Ad of wheels/tires coupled to the electric beam axle 10. Further, the electric beam axle 10 will hereinafter be referred to as the “axle 10”, but it is to be understood that the “electric beam axle 10” and the “axle 10” are used synonymously to refer to the same component/assembly.

The axle 10 is a beam axle for a hybrid and/or electric vehicle (i.e. a hybrid and/or electric automobile), and the axle 10 is configured to transfer rotational energy from an electric motor 14 to the wheels/tires 16 of the vehicle (not shown). In some embodiments, the axle 10 can be a rear axle of the hybrid and/or electric vehicle. In other examples, the axle 10 can be a front axle of the hybrid and/or electric vehicle.

As shown in FIG. 1, the axle 10 includes the electric motor 14, an input shaft 18 adapted to receive rotational energy from the electric motor 14 and transmit it to a shiftable high ratio offset reducer 22, and a final drive with a differential 26 coupled to the shiftable high ratio offset reducer 22.

The electric motor 14 can be an electric motor that converts electrical energy into mechanical energy, such as for example rotational energy that is provided to an output shaft of the electric motor 14. In the illustrated example, the electric motor 14 has an axis of rotation Am that is offset from the axis of rotation Ad of the differential 26.

The input shaft 18 extends between and couples the electric motor 14 to the shiftable high ratio offset reducer 22. More specifically, the input shaft 18 is coupled at a first end to an output shaft of the electric motor 14 for receiving rotational energy from the output shaft of the electric motor 14. The input shaft 18 is coupled at a second end to the shiftable high ratio offset reducer 22 for transferring the rotational energy from the electric motor 14 to the shiftable high ratio offset reducer 22, discussed further below.

The shiftable high ratio offset reducer 22 includes a compound planetary gearset 30 that is shiftable between a first position I and a second position II, as described in more detail below. When position I is selected, the e-axle 10 delivers a normal drive ratio with high efficiency. When position Il is selected, the e-axle 10 delivers a high torque drive ratio with best possible efficiency.

The planetary gearset 30 of the shiftable high ratio offset reducer 22 includes a sun gear 40 driven by the input shaft 18, a first ring gear 44, a second ring gear 48, and a plurality of stepped planet gears 50 supported by a planet carrier 52. Each stepped planet gear 50 includes a large planet gear 56 interposed between the sun gear 40 and the first ring gear 44 and a small planet gear 60 meshing with the second ring gear 48 (e.g., the large planet gear 56 and the small planet gear 60 of each stepped planet gear 50 rotate together, and may be of a unitary one-piece construction). A first clutch 61 is configured to selectively engage the first ring gear 44 (e.g., fix the first ring gear 44 against rotation) and a second clutch 62 is configured to selectively engage the second ring gear 48 (e.g., fix the second ring gear 48 against rotation).

In position I (high range mode), the planet carrier 52 is connected to the final drive/differential 26 for transmitting an output torque from the shiftable high ratio offset reducer 22 to respective wheels 16 of the vehicle (not shown) via axle half shafts 72a and 72b. In the illustrated exemplary embodiment, a pinion gear 74 of the final drive/differential 26 is illustrated while other details of the final drive/differential 26 are not shown. It will be appreciated that aspects of the present disclosure can be used in connection with a wide range of final drives/differentials, and the present disclosure is not limited to use in connection with any particular type of final drive/differential or other transmission components.

In position II (low range mode), the planet carrier 52 is disengaged from the pinion gear 74 a does not transmit torque and the second ring gear 48 is engaged with the pinion gear 74 to provide the high drive ratio.

In operation, the shiftable high ratio offset reducer 22 is shiftable between position I for normal (high) range operations with a combined gear ratio of around i=19, for example, and position II (e.g., closed) having a combined gear ratio of around i=50, for low-range operations. It will be appreciated that other gear ratios are possible.

The axle 10 of the present disclosure results in a simpler and more axially-compact gearing design that still provides the desired gear ratio ranges typical used by, for example, superduty trucks. To this end, the offset arrangement of the electric motor 14, shiftable high ratio reducer 22 and final drive/differential 26 provides an axle 10 having a center-to-center distance Dc of, for example, 50-100 mm, between a rotational axis of the motor Am 14 and the rotational axis Ad of the final drive/differential 26. It should be appreciated that other center-to-center offset distances are possible depending on a particular application.

In one example, an axle 10 in accordance with the present disclosure can realize ratios up to, for example, I=50 based on its described kinematics in a design space that is at least 33% smaller in the axial direction than a conventional design utilizing three axially coupled planetary gearsets. Based on a typical torque for e-Drives in High Duty Truck applications, the above described configuration can save an additional 50 mm of axial design space and approximately 2 kg in weight.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein. It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

10 Electric Beam Axle
14 Electric Motor
16 Wheels/Tires
18 Input Shaft
22 Shiftable High Ratio Offset reducer
26 Final Drive/Differential
30 Planetary Gearset
40 Sun Gear
44 First Ring Gear
48 Second Ring Gear
50 Stepped Planetary Gear
52 Planet Carrier
56 Large Planet Gear
60 Small Planet Gear
61 First Clutch
62 Second Clutch
68 Wheels
72a Axle Half-Shaft
72b Axle Half-Shaft
74 Pinion Gear
Am Axis of Motor
Ad Axis of Differential
Dc Center-to-Center Distance

1. An electric beam axle for a hybrid or electric vehicle, the electric beam axle comprising:
an electric motor;
a shiftable high ratio reducer coupled to the electric motor; and
a final drive coupled to the shiftable high ratio reducer and connectable to a vehicle wheel;
wherein the final drive is offset axially from at least one of the electric motor or shiftable high ratio reducer;
wherein the shiftable high ratio reducer includes a planetary gearset having a plurality of stepped planetary gears supported by a planet carrier;
wherein the planetary gearset includes a first ring gear and a second ring gear;
wherein each stepped planetary gear includes a large planetary gear coupled to the first ring gear and a small planetary gear coupled to the second ring gear, the large planetary gear and the small planetary gear mounted on one pin, and wherein the large planetary gear and small planetary gear rotate together and are connected in a way they can transfer torque; and
wherein the planetary gearset includes a first clutch for selectively engaging the planet carrier with the final drive in a first drive mode.

2-5. (canceled)

6. The electric beam axle of claim 1, wherein the at least one clutch selectively engages the second ring gear with the final drive in a second drive mode.

7. The electric beam axle of claim 6, wherein the planetary gearset has a first gear ratio of between 1:7.5 to 1:10, and a second gear ratio of between 1:2.5 to 1:7.5.

8. The electric beam axle of claim 1, wherein the shiftable high ratio reducer includes an input shaft coupled to the electric motor.

9. The electric beam axle of claim 1, wherein the final drive includes a spur gear differential or a bevel gear differential.

10. A gear train for an electric vehicle comprising:
a shiftable high ratio reducer; and
a final drive coupled to the shiftable high ratio reducer and connectable to a vehicle wheel;
wherein the final drive is offset axially from the shiftable high ratio reducer;
wherein the shiftable high ratio reducer includes a planetary gearset having a plurality of stepped planetary gears supported by a planet carrier;
wherein the planetary gearset includes a first ring gear and a second ring gear;
wherein each stepped planetary gear includes a large planetary gear coupled to the first ring gear and a small planetary gear coupled to the second ring gear, the large planetary gear and the small planetary gear mounted on one pin and wherein the large planetary gear and small planetary gear rotate together and are connected in a way they can transfer torque; and
wherein the planetary gearset includes a first clutch for selectively engaging the planet carrier with the final drive in a first drive mode.

11-14. (canceled)

15. The gear train of claim 10, wherein the at least one clutch selectively engages the second ring gear with the final drive in a second drive mode.

16. The gear train of claim 15, wherein the planetary gearset has a first gear ratio of between 1:7.5 to 1:10, and a second gear ratio of between 1:2.5 to 1:7.5.

17. The gear train of claim 10, wherein the shiftable high ratio reducer includes an input shaft.

18. The gear train of claim 10, wherein the final drive includes a spur gear differential or a bevel gear differential.
